(19) United States
(12) Patent Application Publication
(10) Pub. No.: US 2008/0159482 A1
(43) Pub. Date: Jul. 3, 2008

(54) Medical system with user interface embodied to allow switchover

(76) Inventors: Philipp Quaet-Faslem, Munchen (DE); Judith Regn, Nurnberg (DE); Reiner Staab, Baiersdorf (DE); Susanne Staab, Baiersdorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/900,818

(22) Filed: Sep. 13, 2007

(30) Foreign Application Priority Data
Sep. 14, 2006 (DE) 10 2006 043 146.4

(51) Int. Cl. H05G 1/64

(52) U.S. Cl. 378/98

(57) ABSTRACT

The invention relates to a medical system with a medical device, especially an x-ray, a C-arm x-ray, a computer tomograph, a magnetic resonance tomograph or an ultrasound tomograph. The medical device features a control input for receiving a control signal and can be controlled as a function of the control signal. The medical system also features a user interface with a control facility to allow control by a user. The control facility is, depending on a movement of the control element, for generating the control signal. The user interface features a selection facility and at least two facility interfaces being effectively connected to the selection facility. The facility interfaces are each for connection to a control input of the at least two medical devices. The selection facility is for connecting the control facility to at least one or precisely one facility interface.

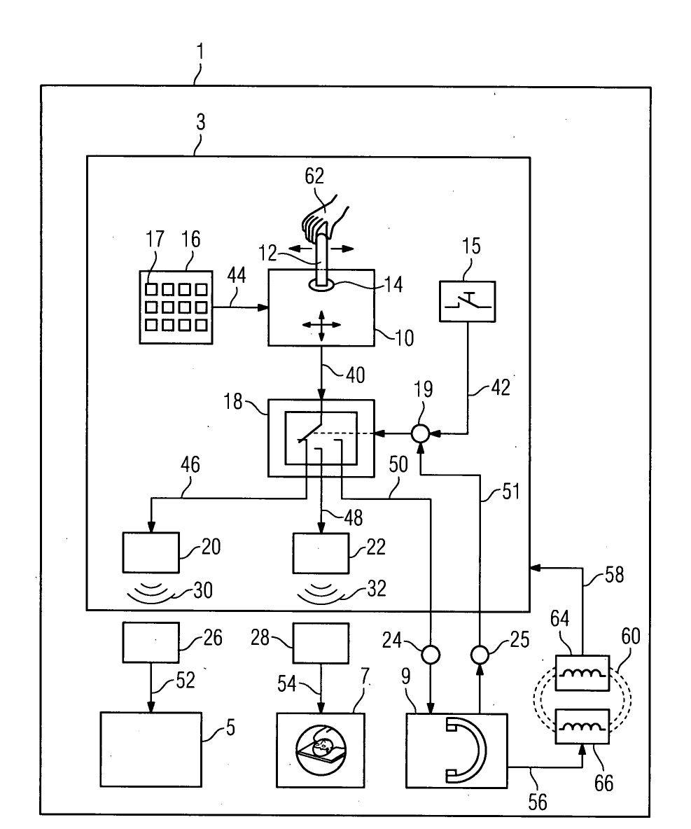

### CROSS REFERENCE TO RELATED APPLICATIONS

This application claims priority of German application No. 10 2006 043 146.4 filed Sep. 14, 2006, which is incorporated by reference herein in its entirety.

### FIELD OF THE INVENTION

The invention relates to a medical system with at least one medical device, especially an x-ray device, a C-arm x-ray device, a computer tomograph, a magnetic resonance tomograph or an ultrasound tomograph. The at least one medical device features a control input for receiving a control signal and is embodied to allow it to be controlled as a function of the control signal. The medical system also features a user interface with a control facility embodied to allow control by a user. The control facility is embodied, depending on a movement of the control element, for generating the control signal to control the at least one medical device.

### BACKGROUND OF THE INVENTION

In the medical systems known from the prior art with at least one medical device there is the problem of each medical device being assigned to at least one control element, which must be operated by a user, for example a doctor.

### SUMMARY OF THE INVENTION

The object underlying the invention is to specify a device of the type mentioned at the start which allows simplified operation by a user.

This object is achieved by a device of the type mentioned at the start, with the user interface having a selection facility and at least two facility interfaces, with each of the two facility interfaces having an effective connection to the selection facility. The facility interfaces are each embodied for connection to a control input of the at least two medical devices. The selection facility is embodied for connecting the control facility with at least one or precisely one facility interface. A medical system of the above type advantageously allows savings to be made in control elements, which makes it easier for a user, especially a doctor, to operate the medical system.

A medical device can for example be formed by a medical module of the medical system. A medical module can for example process a result recorded by a medical recording device, especially of a computer tomograph, a C-arm x-ray device or an ultrasound tomograph.

For example a medical module can generate from a 3D dataset, which represents a result of a recording of an object in three dimensions, a dataset which represents a sectional presentation of the object, a view onto the object or a view through the object, and transmit this to an image display unit. The medical module features a control input and is embodied for receiving a control signal and, depending on the control signal, for showing a sectional display of the object, creating a view onto the object or a view through the object or changing a direction of display. For example the medical module, depending on the control signal, can create a view of the object in a rotated representation and can create a corresponding dataset for this and transmit this to the image display unit.

In a preferred embodiment at least one facility interface is embodied for wired connection to the at least one medical device. To this end the at least one facility interface can feature electrical contacts for electrical connection to the medical device. In another embodiment the at least one facility interface is embodied for wired connection to the at least one medical device. An interface for wired connection can be an interface for fiber-optic connection.

In a preferred embodiment at least one facility interface is embodied for wire-free, especially wireless or cordless connection to the at least one medical device, and especially to the control input of said device. The facility interface can for example be embodied as a radio interface, especially as a WLAN (Wireless Local Area Network) interface, as a Bluetooth interface or as an optical interface, especially an infrared interface. A facility interface for wireless connection advantageously enables the user interface to be used easily and flexibly.

For example the user interface can be embodied as a mobile user interface, with the user interface in this embodiment being able to be supplied wirelessly with electrical energy, especially for operating components of the user interface. This allows the user interface to advantageously be supplied in a safe manner with electrical energy, with another advantage being that batteries used to operate the user interface can advantageously also be saved.

In an advantageous embodiment the user interface can be separately coupled inductively to the medical device and the medical system in this form is embodied for transmitting inductively to the user interface the electrical energy to supply the user interface.

Inductive transmission enables the user interface for example to receive electrical energy through a housing wall of a housing of the user interface. The housing wall of the user interface can advantageously feature a surface facing outwards which can be cleaned antiseptically in a simple manner. This has the advantage that no electrical contacts for connecting the user interface to an energy source are bought out of the user interface, which could enable germs to accumulate in the area of the contacts.

In an advantageous embodiment the selection device is embodied for connecting the control facility depending on a user interaction signal with the at least one or the precisely one facility interface. A user interaction signal can for example be generated by means of a key or a touch-sensitive surface. In this way a user of the medical system can advantageously—for example by actuating the key or touching the touch-sensitive surface—generate a user interaction signal indirectly and connect the user interface, especially the control facility, to a medical device for farther control.

In a preferred embodiment the medical system is embodied, depending on a result, especially on a process, especially on a process status or process sequence of a process running in the medical system, to create a switchover signal representing a medical device. The selection facility is embodied in this embodiment for connecting the control facility as a function of the switchover signal to the medical device represented by the switchover signal and in this device to the facility interface.

An event can for example be generated outside the medical system and represented by an event signal which can be received by the medical system.

For example a medical recording device, especially a computer tomograph, can be controlled by means of the user interface by a user during a recording process. If the recording process is ended by the computer tomograph, the medical system can for example generate a switchover signal for disconnecting the user interface from the computer tomograph and for reconnecting the user interface to an ultrasound tomograph.

In a further recording process—for example an object, especially a patient, can be recorded in this process—the ultrasound tomograph can be controlled by means of the user interface, for example guided by a user's hand.

In addition to the switchover signal described previously, the user interface can be disconnected from a medical device, depending on a user interaction signal for example, and can be connected to another medical device. This enables a user to advantageously intervene manually into a process-dependent controlled medical system.

Also conceivable is a simultaneous connection of the control facility to two medical devices. For example in this way the medical device for spatial positioning of a tool, especially a guidance wire or a catheter, can be simultaneously connected to a medical device for creating a—corresponding to the position of the tool—two-dimensional representation from a 3D recording result. The 3D recording result can for example be created by means of a computer tomograph and represent an object recorded by the latter in three dimensions.

in a preferred embodiment of the medical system the control element is indirectly connected at least to the control facility, and preferably the control element and/or the control facility are each embodied to enable them to be moved with at least one rotational degree of freedom. The control facility is embodied to record the movement of the control element and to generate the control signal as a function of the movement of the control element. In this case the control signal represents at least the degree of freedom and/or a direction of movement of the control element. For example the control element can be formed by a control bar, which has a pivot connection with at least one rotational, or to two or three rotational degrees of freedom to the control facility, especially to a housing or frame of the control facility. To this end the control bar can be connected by means of at least one pivot joint for one rotational degree of freedom, or by a ball joint to the control facility. This allows a user of the user interface to advantageously operate the medical system intuitively by pivoting the control element.

In a preferred embodiment—independent of or in addition to a movement of the control element in at least one rotational degree of freedom—the control element is connected to the control facility at least indirectly, and preferably the control element and/or the control device are each embodied such that the control element can be moved in a translational degree of freedom.

To this end the control element is preferably connected by means of at least one slide bearing, especially for a translational degree of freedom, to the control facility. For example the control element can be a control head which, especially when displaced by means of a human hand, can be moved in at least one translational degree of freedom.

Also conceivable is a control facility with a combination of translation and rotation. In this case the control facility features a control element connected to the control facility to allow movement, which can be moved in at least one translational and/or at least one rotational degree of freedom.

A control element can for example be formed by a shaped body able to be gripped by a human hand. The control element can be connected by spring elements to a housing of the control facility in such a way that the control element can be moved in at least two, or three translational degrees of freedom and/or in at least two or three rotational degrees of freedom.

In an advantageous embodiment the user interface features an input panel connected at least indirectly to the selection facility, which is embodied, at least as a function of being touched by a user, to generate the control signal and to output this signal on the output side. To this end the input panel can be embodied as a touch-sensitive surface which, as a function of being touched by a user, can create a control signal which represents a location of the touch. Advantageously the input panel can be an image display unit with a touch-sensitive surface.

In another embodiment the input panel can be a keypad or a keyboard with at least one key and can generate the control signal as a function of a key press.

Further advantageous embodiments emerge from the features referred to in the dependent claims or from a combination of said claims.

### BRIEF DESCRIPTION OF THE DRAWINGS

The invention will be explained below with reference to a FIGURE which shows a schematic diagram of a medical system and further exemplary embodiments.

### DETAILED DESCRIPTION OF THE INVENTION

The FIGURE shows a schematic diagram of a medical system 1. The medical system 1 includes a user interface 3, a medical device 5, a medical device 7 and a medical device 9. Medical device 5 is an ultrasound tomograph, medical device 7 is a magnetic resonance tomograph and medical device 9 is a C-arm x-ray device. The user interface 3 features a control facility 10 with a control element 12. The control element 12 is connected by means of a pivot bearing 14 to the control facility 10. The pivot bearing 14 is for example embodied as a ball joint, comprising a step bearing and a ball head connected to the control element 12. The control facility 10 is embodied to detect a movement of the control element 12, especially a pivoting of the control element 12 and to create a control signal which at least represents a degree of freedom of the pivot arm and/or one pivot direction. For example the control element 12 can be moved by means of a user's hand 62.

The user interface 3 also features an input panel 16. The input panel 16 includes a plurality of keys of which key 17 is taken as a typical example.

The user interface 3 also includes a selection facility 18. The user interface 3 also includes a facility interface 20 and a facility interface 22, which are each provided for wireless connection to a medical device. The facility interfaces 20 and 22 can for example be embodied in each case as a radio interface, especially as a Bluetooth interface or as an optical interface, especially as an infrared interface. The medical device 9 features a control input 24 and a control output 25.

The medical device 5 features a control input which is embodied as control interface 26. The medical device 7 features a control input which is embodied as control interface 28. The control interfaces 26 and 28 are each embodied for wireless reception of a control signal. The FIGURE shows a wirelessly transmitted control signal 30 which was sent by the facility interface 20 and which can be received by the control interface 26. The FIGURE also shows a wirelessly transmitted control signal 32 which was sent by the facility interface 22 and which can be received by the control interface 28. The control interfaces 26 and 28 can each be embodied as a radio interface, especially as a Bluetooth interface or as an optical interface, especially as an infrared interface.

The control facility 10 is connected on the output side via a connecting line 40 to the selection facility 8. The selection facility 18 is connected on the input side via the connecting line 40 to the control facility and on the output side via a connecting line 46 to the facility interface 20, on the output side via a connecting line 48 to the facility interface 22 and on the output side via a connecting line 50 to the control input 24. The selection facility 18 has an input 19 for a switchover signal. The selection facility 18 is connected on the input side via a connecting line 42 to a key 15 of the user interface 3. The selection facility 18 is also connected on the input side via a connecting line 51 to the control output 25 of the medical device 9. The selection facility I 8 is embodied to output on the output side via the connecting line 46, the connecting line 48 or the connecting line 50 a control signal received via the connecting line 40 created by the control facility 10 depending on a switchover signal received via the connecting line 42 or on the input side via the connecting line 51.

The selection facility 18 can to this end for example include at least one flip-flop element which is embodied, depending on the switchover signal received via the connecting line 42 and/or on the switchover signal received via the connecting line 51, to output the control signal received via the connecting line 40 on the input side to the connecting line 46, the connecting line 48, or the connecting line 50. The at least one flip-flop element can for example maintain a connection established between the connecting line 40 and the connecting line 46 and disconnect it depending on the switchover signal received via the connecting line 42 or via the connecting line 51 and connect the connecting line 40 to the connecting line 48 and maintain this connection. The selection facility 18, depending on a new switchover signal received, can disconnect the connection established between the connecting line 40 and the connecting line 48 and connect the connecting line 40 to the connecting line 50.

The medical device 9 can for example create a switchover signal as a function of a process status executing in the medical device 9, for example if a process of recording images of a patient is completed, and output the switchover signal thus created to the control output 25. The control signal thus created can be received via the connecting line 51 of the selection facility 18. The selection facility 18 can, depending on the switchover signal received via the connecting line 51, disconnect the control facility 10, which for example was previously effectively connected to the control input 24 of the medical device 9, from the control input 24 and effectively connect it to the medical device 5 embodied as an ultrasound tomograph.

A movement of the control element 12—for example by means of a user's hand 62—can now be subsequently be detected by the control facility 10, which can create a corresponding control signal and can send this on the output side via the connecting line 40 to the selection facility 18. The selection facility 18 can send the control signal thus received, depending on the switching status of the selection facility 18, on the output side via the connecting line 46 to the facility interface 20, or via the connecting line 48 to the facility interface 22 or via the connecting line 50 to the control input 24.

In this exemplary embodiment the selection facility 18 connects the connecting line 40 to the connecting line 46. The control signal created by the control facility 10 can thus be received by the facility interface 20 and a corresponding wirelessly-transmitted control signal 30 can be generated by the latter. The wirelessly-transmitted control signal 30 can be received by the control interface 26. The control interface 26 is connected via a connecting line 52 on the output side to the medical device 5. The medical device 5 can thus receive the control signal created by the control facility 10 or can receive a control signal corresponding to this, created by the interface 26. The control signal thus received can for example cause an ultrasound recording process to be started.

For a manually-controlled switchover a user can for example create a switchover signal by means of the key 15. This switchover signal can be received via the connecting line 42 of the selection facility 18, whereupon the selection facility 18 can connect the connecting line 40 to the connecting line 48 and can thus output control signals received on the input side via the connecting line 40 to the connecting line 48 on the output side. The facility interface 22 can generate a correspondingly wirelessly-transmitted control signal 32 and send this to the control interface 28.

The control interface 28 is connected via a connecting line 54 to the medical device 7. Depending on the control signal received in this way via the control interface 28, the medical device 7 can for example start a recording process for recording images of a patient by means of magnetic resonance.

A user of the user interface 3 can for example cause a control signal, which can be sent via the connecting line 44 to the control device 10, to be generated by means of the key panel 16 by pressing a key 17. The control facility 10 can output the control signal thus received via the connecting line 40.

The input panel 16 can be formed by a touch-sensitive surface. Keys of the input panel 16 can each be formed by a movably supported key element. The input panel 16 can for example be connected in another embodiment wirelessly or cordlessly to the user interface 3. To this end the input panel 16 can for example feature a radio interface—not shown in this embodiment—especially a Bluetooth interface or an optical interface, especially an infrared interface. Interfaces 24 and 25 can each have contacts for disconnecting a connecting line. The user interface 3 can thus be a mobile user interface 3 which can interoperate in a medical system together with at least two or more medical devices.

The user interface 3 can feature an inductive interface 64. The user interface 3 is then connected on the input side via a connecting line 58 to the inductive interface 64 and can receive, by means of the inductive interface 64, electrical energy for operating the control facility 10, the selection facility 18 and the facility interfaces 20 and 22. The inductive interface 64 can generate the electrical energy by self-induction from a received magnetic flux—for example from the electrical coil included in the inductive interface 64—of a magnetic near field 60. The magnetic near field 60 is created in this exemplary embodiment by an inductive interface 66 connected to a medical device 9, which is connected via a connecting line 56 to the medical device 9. In this way the medical device 9 can supply the user interface 3 with electrical energy. The inductive interface 66 and the inductive interface 64 are thus coupled to each other by means of the magnetic near field 60.

Unlike in the embodiment of the medical system 1 shown in this FIGURE, the user interface can have no input panel. The input panel 16 can then be a component of the medical system, but not a component of the user interface 3. The input panel 16 in this embodiment for example can be connected by means of an interface, comprising electrical contacts, to the user interface 3, and there can especially be connected to the control facility 10 in a disconnectable manner.

1-10. (canceled)

11. A medical system, comprising:
a medical device comprising a control input that receives a control signal for controlling the medical device; and
a user interface comprising:
a control unit comprising a control element that generates the control signal depending on a movement of the control element,
a selection unit that connects the control unit with the control input of the medical device via a unit interface.

12. The medical system as claimed in claim 11, wherein the medical device is wiredly connected with the unit interface.

13. The medical system as claimed in claim 11, wherein the medical device is wirelessly connected with the unit interface.

14. The medical system as claimed in claim 11, wherein the user interface is operated by a wirelessly supplied electrical energy.

15. The medical system as claimed in claim 14, wherein the user interface is inductively coupled to the medical device.

16. The medical system as claimed in claim 15, wherein the electrical energy is inductively transmitted to the user interface from the medical device.

17. The medical system as claimed in claim 11, wherein the selection unit connects the control unit to the medical device as a function of a user interaction signal.

18. The medical system as claimed in claim 11, wherein the medical system comprises a plurality of medical devices.

19. The medical system as claimed in claim 18, wherein the medical system generates a switchover signal representing one of the medical devices and the selection unit connects the control unit to the represented one medical device based on the switchover signal.

20. The medical system as claimed in claim 11, wherein the control element is connected to the control unit and moved with a rotational degree of freedom.

21. The medical system as claimed in claim 20, wherein the user interface records the movement of the control element and generates the control signal representing the rotational degree of freedom or a direction of the movement.

22. The medical system as claimed in claim 11, wherein the control element is connected to the control unit and moved with a translational degree of freedom.

23. The medical system as claimed in claim 22, wherein the user interface records the movement of the control element and generates the control signal representing the translational degree of freedom or a direction of the movement

24. The medical system as claimed in claim 11, wherein the user interface comprises a user input panel connected to the selection unit.

25. A method for controlling a medical device in a medical system, comprising:
generating a control signal depending on a movement of a control element arranged in a control unit;
connecting the control unit with the medical device via a unit interface; and
controlling the medical device depending on the control signal.

26. The method as claimed in claim 25, wherein the selection unit connects the control unit to the medical device as a function of a user interaction signal.

27. The method as claimed in claim 25, wherein the medical system comprises a plurality of medical devices.

28. The method as claimed in claim 27, wherein the medical system generates a switchover signal representing one of the medical devices and the selection unit connects the control unit to the represented one medical device based on the switchover signal.
